(19) United States
(12) Patent Application Publication
(10) Pub. No.: US 2025/0095052 A1
(43) Pub. Date: Mar. 20, 2025

(54) Fully Automated Ticket Distribution System

(71) Applicants: Ryan Clare, Wellesley, MA (US); Truman Gelnovatch, Miami, FL (US)

(72) Inventors: Ryan Clare, Wellesley, MA (US); Truman Gelnovatch, Miami, FL (US)

(21) Appl. No.: 18/811,688

(22) Filed: Aug. 21, 2024

Related U.S. Application Data
(60) Provisional application No. 63/534,102, filed on Aug. 22, 2023.

(51) Int. Cl. G06Q 30/0601; G06Q 30/0201

(52) U.S. Cl. CPC G06Q 30/0641; G06Q 30/0206

(57) ABSTRACT

A system designed to facilitate the end-to-end selling of event tickets. A system is described which allows single action dynamic market listing and distribution. This system includes graphical user interfaces (GUIs) for uploading, selling, and purchasing listed tickets.

### TECHNICAL FIELD

The presently disclosed embodiments are related, in general, to live event retail. More specifically, the presently disclosed embodiments are related to methods and services for real time management of an automated ticketing distribution system.

### BACKGROUND OF INVENTION

Currently available mechanisms for selling tickets are time-consuming and inefficient for individual retailers. Optimally reacting to market signals is a non-trivial process (e.g., may require expertise in fields such as network processing and the ability to collect data, process data, and make calculations at speeds impossible for a human to achieve) and requires significant overhead to manually change a ticket's price across multiple exchanges. Those skilled in the art will appreciate the efficiency gained from an end-to-end automated selling and distribution system. Individual sellers, who may have thousands of tickets to a single event, are simply not as adept at reacting to changing market conditions as an automated system.

### SUMMARY

According to the embodiments illustrated herein, there is provided a system for facilitating the end-to-end transaction of tickets. This system includes, but is not limited to, a ticket upload module and interface, a seller's dashboard which includes a single action user interface (UI) element for initiating the automated sale of a ticket, an automated pricing system which leverages machine learning methods to adapt to real time inputs, a purchasing interface which demonstrates the price of available tickets with the option to buy them, and a ticket verification system which allows the entry of a purchased ticket into its corresponding event. The system further includes algorithmic logic adapted to make each of these modules function as described in the present application.

The automated pricing system ingests data points including, but not limited to, past sales history, website traffic data, consumer click data, event specific information, time to event start, and current weather conditions, to optimally price an individual ticket holder's tickets. This system is significantly different from prior methods of selling an individual's tickets in that it can adapt to any market changes, is not solely dependent on any one factor (e.g., time to event start), and can distribute tickets across multiple exchanges. This system includes a unique pipeline for training said algorithm and evaluating its efficacy. Such a system therefore includes a training module as well as various evaluation metrics which may be considered an embodiment of its own testing system. An abstracted embodiment of this automated pricing system is depicted in FIG. 4 and described in detail later in the present application.

This automated pricing system is combined with a single action ticket upload module and a selling dashboard. A user is first prompted to upload tickets to the exchange using an embodiment of the single action upload system shown in FIG. 2. Once populated in the system, a user is prompted via the seller's dashboard (an embodiment of which is displayed in FIG. 3) for single action listing of their tickets on the exchange. Once transacted, the pricing system dynamically facilitates the selling of such tickets on the exchange (and onto any other platform which the system broadcasts to). Such tickets can then be purchased through the platform's buyer interface (an embodiment of which is shown in FIG. 5) or another analogous buyer interface on another website/platform which displays user interface elements necessary to inform the buyer and thereby facilitate their purchase decision. Once purchased, these tickets can then be used to enter an event through a ticket verification system, an embodiment of which is depicted in FIG. 7.

The disclosed technologies address the inefficiencies of current ticket selling mechanisms by providing a fully reactive end-to-end exchange platform. It enables individual sellers to upload event tickets, utilize a dynamic automated pricing system based on real-time market data, and offers a streamlined interface for sellers and buyers to facilitate ticket transfer in a time saving manner. The system's unique algorithmic logic considers various inputs and adapts to market changes, ensuring optimal pricing. This system is further separated from existing methods in that it prices and reprices the same ticket over time (possibly every minute), ensuring consistent, quality pricing decisions. Additionally, it includes a training module and an evaluation module to ensure algorithmic efficacy. The single action upload process and dedicated buyer interface enhance efficiency and profitability for sellers, making the disclosed technologies a comprehensive solution for ticket selling automation.

### BRIEF DESCRIPTION OF DRAWINGS

In the following section, specific embodiments of the disclosed technologies will be described in greater detail in connection with illustrative but non-restrictive examples. The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram that illustrates a high-level, abstracted system overview, in which various embodiments can be implemented, in accordance with at least one embodiment;

FIG. 2 is a block diagram that illustrates a ticket upload module, in accordance with at least one embodiment;

FIG. 3 illustrates an exemplary graphical user interface (GUI) that represents a possible seller's dashboard, in accordance with at least one embodiment;

FIG. 4 is a block diagram that illustrates a high-level overview of a ticket automated pricing system, in accordance with at least one embodiment;

FIG. 5 illustrates an exemplary graphical user interface (GUI) that represents a possible ticket purchasing interface, in accordance with at least one embodiment;

FIG. 6 is a diagram that illustrates a system of network communication for the invention described herein, in accordance with at least one embodiment;

FIG. 7 is a diagram which demonstrates an embodiment of an event entry module. One or more tickets from the presently disclosed invention can be used to gain entry to an event through such a system.

### DETAILED DESCRIPTION

The present disclosure is best understood with reference to the detailed figures and descriptions set forth hereinafter. Various embodiments are discussed below with reference to the figures. However, those skilled in the art will readily appreciate that the detailed descriptions given hereinafter with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

The disclosed technologies represent significant improvements in the overall speed, reach, and profitability for individual ticket sellers. It is important to note that this innovative system would not necessarily hurt ticket buyers and may offer them multiple benefits. For example, this exchange provides a more consistent system for setting prices, based on the same algorithmic logic and sources of data for each ticket, than existing approaches of letting each individual user make their own arbitrary pricing decisions. Further limitations and disadvantages of conventional and traditional approaches to selling tickets will become apparent to one of skill in the art, through comparison of existing systems with some aspects of the present disclosure, as set forth in the remainder of the present application with reference to the drawings.

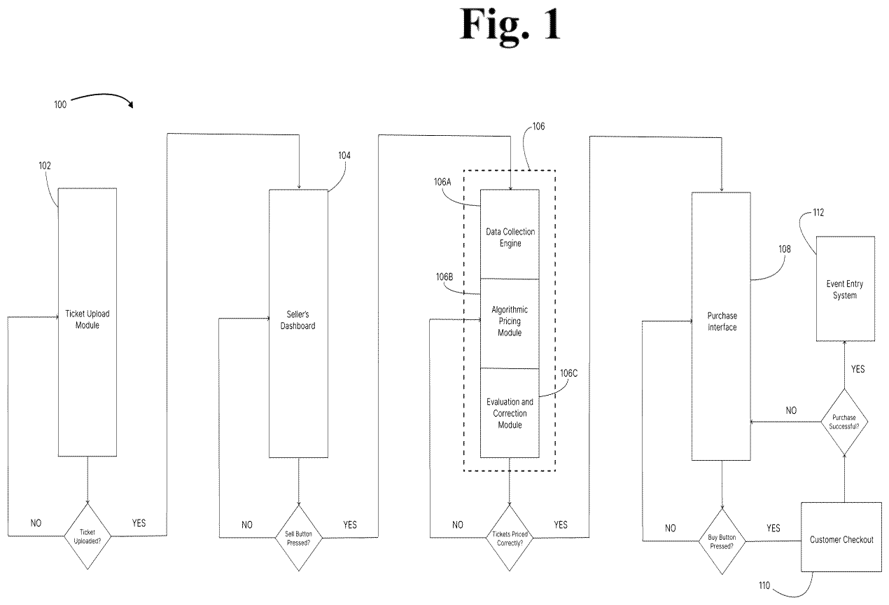

FIG. 1 is a block diagram depicting, in an abstract and high-level manner, an embodiment of how each of the main modules interact together. With reference to FIG. 1, there is shown a system environment 100 that includes a ticket upload module 102, a ticket selling dashboard 104, a ticket automated pricing system 106, an informational ticket purchasing dashboard 108, and an event entry system 112. Each of these separate systems are demonstrated in other figures and described in detail hereinafter. Not included in these depictions are embodiments of the actual interface or algorithmic logic necessary to implement the functionality of each process.

The disclosed technologies can include each of the separate modules, specifically 102, 104, 106, 108, 110, and 112, in an innovative ticket exchange system. A user of this system would first need to upload their tickets to the platform using the upload module 102. After completing the upload process, these tickets may be populated into that user's selling dashboard 104, which includes UI elements and the algorithmic logic adapted to execute a single action listing of any existing ticket to the exchange. Once a ticket has been listed on the exchange, the automated pricing system 106 is used to facilitate the process of periodically (in deterministic or non-deterministic intervals of time) updating the ticket price. The inputs, goals, and algorithmic logic of the automated pricing system 106 are described later in this section. 106A depicts the data collection engine which is used to provide inputs to the automated pricing system 106. 106B and 106C reflect the pricing and evaluation modules which are subsets of the overall automated pricing system 106. The automated pricing system 106 is directly tied to the purchasing interface 108 which reflects the real time prices of tickets on the exchange (or any other exchange which the system broadcasts its tickets to) and contains other signals used to properly inform a potential ticket buyer. Once a buyer decides to purchase a ticket, they are taken through a customer checkout flow 110. Upon successful checkout, the user can then enter the event entry system 112 on the date and time of the ticket's event. This system will provide legitimate ticket owners entry to the event using a ticket verification machine.

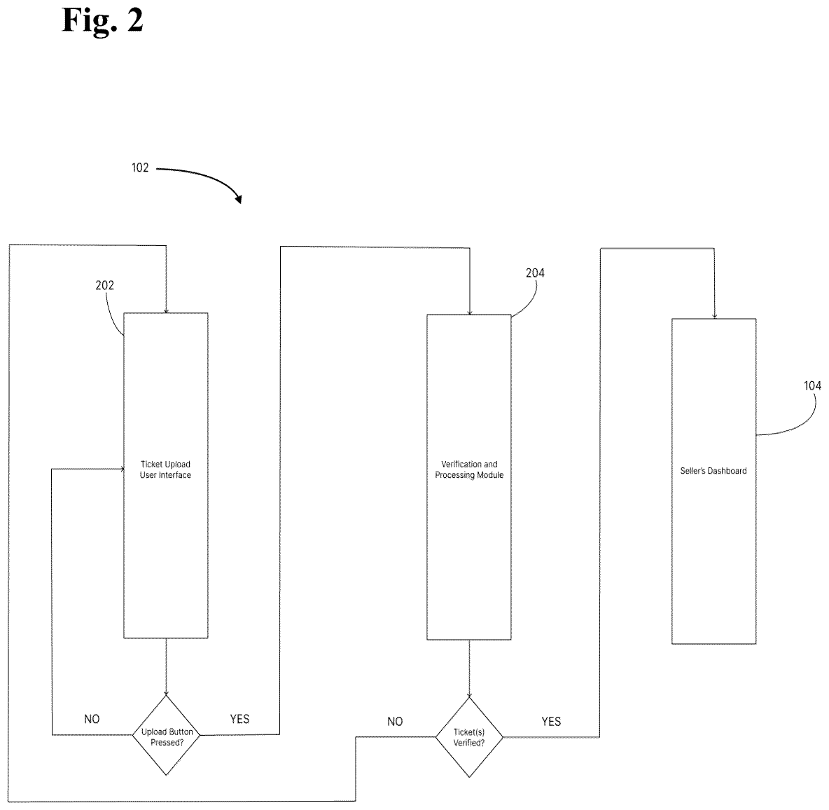

FIG. 2 shows an illustrative but non-restrictive depiction of a ticket upload module 102. This module is designed for the simple upload of tickets to the seller's dashboard 104. The module includes a GUI 202 which allows a user to upload tickets to the platform in any of the following ways: scanning a barcode, typing in a barcode, or transferring tickets from another application. These are just some of the possible controls that could allow a user to upload a ticket and does not exclude other forms of performing such a task. Once the user signals that the tickets are ready for upload, these tickets are transferred to the verification and processing module 204. The user control signal described in FIG. 2 is the push of an “Upload Button”. However, this is simply an embodiment of any signal a user could give to indicate the intention of uploading one or more tickets. The verification and processing module 204 performs the task of verifying the ticket and transforming it into a version suitable for the platform. The verification process may include comparing the ticket barcode against existing barcode records, checking the identity of the user to be a trusted entity, or any other algorithmic logic necessary to confirm the validity of the ticket. This module 204 will additionally perform the task of processing the ticket for use in the seller's dashboard or any other part of the platform deemed necessary to include the ticket. Ticket processing may include, but is not limited to, adding the ticket information to a database of ticket records, pulling additional information about the ticket from outside sources of information, and or creating a custom Non-fungible Token (NFT) reflecting and representing the ticket on the platform. Module 204 thus contains any algorithmic logic suitable to perform the embodiments of the verification and processing tasks described herein. Finally, if a ticket successfully passes all verification steps and is processed correctly, then the ticket will be populated in a user's selling dashboard 104. The seller's dashboard 104 is described in detail in the next paragraph but is not the only place a ticket or a ticket's information may be stored on the platform or in the platform's associated databases.

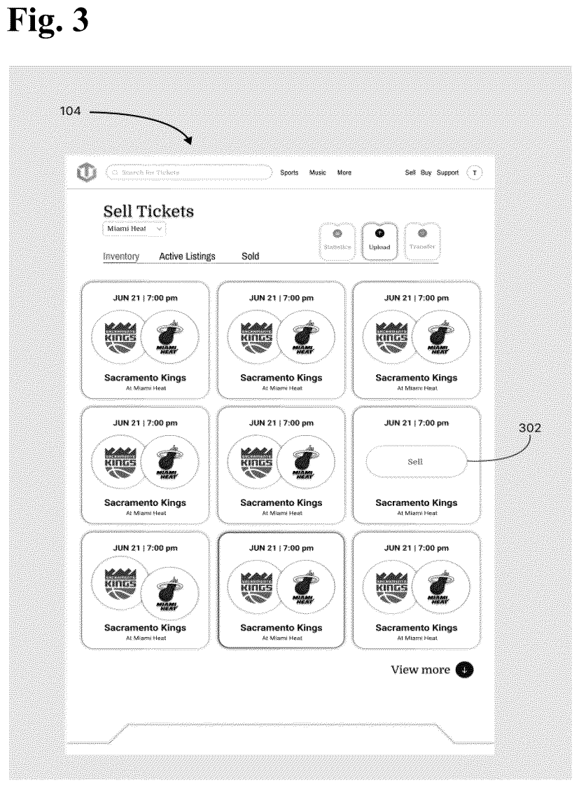

The display in FIG. 3 is an embodiment of the seller's dashboard 104. This FIG. 104 represents a possible depiction of such a dashboard but is in no way limited to the specific elements therein. Additionally, more elements may be added to the GUI in order to achieve the functionality set forth in the present application. This dashboard informs the user which tickets are currently available for sale, which tickets are currently listed on the market (with the ability to take these tickets off of the market if they have not already sold), and which tickets have already sold. The dashboard is not limited to these aforementioned functionalities and may provide the user with any information necessary to make a decision on which tickets to sell or not sell. This information may include, but is not limited to, statistics about current market trends, data on how a user's previous tickets were sold, and a projected price that these tickets would fetch.

The GUI 104 includes controls which allow a user to list their ticket(s) on the exchange. These elements, embodied by the “Sell” button 302 in FIG. 3, are single action methods for a user to dynamically list their tickets on the exchange utilizing the automated pricing system 106. The seller's dashboard may also include controls to take a ticket off of the market or “stop selling” said ticket. The UI in FIG. 3 is that which may be displayed on a website. However, any UI with the described functionality would encompass such a dashboard (e.g., the interface could be on a phone, tablet, etc.). Not depicted is an embodiment of a seller's statistics UI. This interface would include the aforementioned information that may be useful to inform a user's sales decisions.

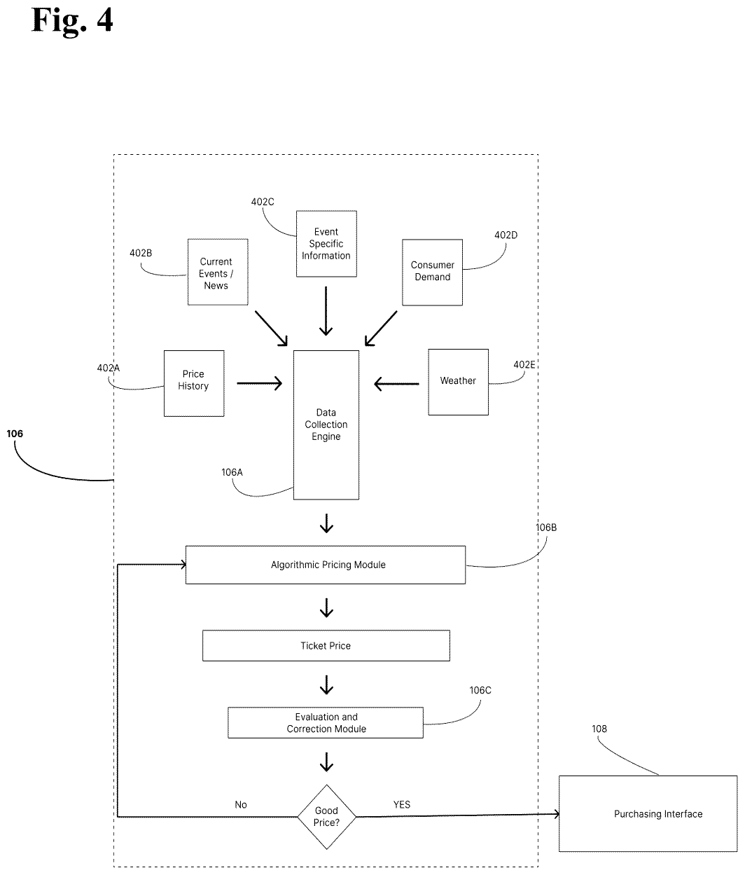

FIG. 4 is an abstracted embodiment of the automated pricing system 106. The overall function of this system is to price tickets according to the inputs 402A-402E to the data collection engine and dynamically adjust these prices based on changes to the inputs. The data collection engine 106A serves to gather and store the data which is later utilized by the algorithmic logic modules 106B and 106C. The data collection engine 106A may store the data in a relational database, a non-relational database, hard disk storage, a data lake, a data warehouse, cache storage, or any other form of storage medium. Further, the data collection engine 106A needs algorithmic logic capable of extracting the inputs from their various possible sources and storing them in a structured, accessible format. The inputs 402A-402E to the data collection engine 106A serve as examples for what kind of data might be useful in determining a ticket's price. Price history 402A includes the sales history of the exchange described herein as well as the price history of other retail ticketing platforms. Moreover, the word “history” is not limited to the past and does not exclude real time price data from these other platforms as well. Price history 402A may be useful in gauging current and past market trends to determine an accurate price. Current events/news 402B may include any form of media, whether that be social media, television programs, news articles, works of scholarship, etc. In order to extract useful information out of these relatively unstructured media, processing algorithms such as techniques in the field of Natural Language Processing (NLP) may be used. Similarly, NLP techniques may be applied to any form of media which pertain to the event-specific information 402C. This type of data includes player or artist availability, which teams are playing (if the event is a sporting one), what time the event takes place, what other events are happening at the same time, as well as any other information specific to the event which the ticket is for. Consumer demand 402D may be gauged in a number of ways. First, software-specific measures may be used such as web or network traffic data and consumer click data (for the exchange described herein or any other platform). Demand measures are not solely determined by network attributes and may be gauged by public sentiment (using various forms of media), demand history, and or external characteristics such as highway traffic patterns. Weather 402E is straightforward and may be measured by hardware sensors or retrieved from any external data sources. Those skilled in the art will appreciate that many more factors, not described herein, may be useful in determining ticket price. The data collection engine 106A and the overall automated pricing system 106 are therefore not limited to the inputs 402A-402E referenced in FIG. 4 and may include any other possible input. This exchange is unique in that its pricing system can react to changes in any input due to the combination of its data collection engine 106 and machine learning based algorithmic logic which does not deterministically only ever increase or decrease ticket price. Also included in this system, but not depicted, is any hardware, software, and logic necessary to procure any and all of the inputs 402A-402E as well as any potential inputs not listed herein. Instances of these collection vehicles could be weather sensors, web scraping processes, network monitoring hardware or applications, any form of news or media, direct data application programming interfaces (APIs), and the algorithmic logic used to process the raw data.

The data collection engine 106A gathers and stores the data to then be passed to the algorithmic pricing module 106B. The algorithmic pricing module 106B contains any and all logic used to transform the data into a digestible format for the machine learning processes. This logic may include removing categorical variables (e.g., through one-hot encoding), normalizing the variables (e.g., by centering the variables at 0 with single unit variance), replacing missing data, and or using unsupervised learning algorithms to extract features from such data. Those skilled in the art will appreciate that data preprocessing is an important part of a machine learning pipeline and may include other processes not listed herein. After pre-processing, the data is then used by the system to determine a price for the current ticket(s). The system may utilize one or more machine learning algorithmic processes to make such a determination. Such processes may include supervised learning methods, unsupervised learning methods, or reinforcement learning methods. Multiple of these methods may also be combined and the type of learning process may be shallow or deep as in a neural network-based architecture. Any training or optimization methods necessary to enhance the quality of the machine learning process(es) will be performed in this module. The goal of the algorithmic training module 106B is to output a suitable ticket price. The training data may include historical ticket price data, along with the various other historical factors that the data collection engine 106A gathers, and may be rewarded or corrected by previous sales. The models may additionally or exclusively learn off of live data and the frequency of sales in such an environment. The evaluation and correction module 106C determines whether the current price is suitable and accurate (note that the algorithmic pricing module 106B and the evaluation and correction module 106C have many interrelated functions and do not necessarily represent two distinct entities). To make such a determination, the evaluation and correction module 106C may use any and all of the data points stored in the data collection engine 106A, any outside evaluation characteristics, and perform any calculations deemed necessary to make such a decision. Evaluation characteristics may include how quickly the ticket is projected to sell, what price consumers are gauged to pay for the ticket, and/or how close the ticket price is to its projected market value or the price of other comparable tickets. In addition, the evaluation and correction module 106C may correct the ticket price if the evaluation and correction module 106C finds a way to do so without having to re-run the algorithmic pricing module 106B. Such corrections may also include adjusting the algorithmic pricing module 106B and manipulating the data collection engine 106A or its inputs 402A-402E. After any corrections, if the evaluation and correction module 106C deems the ticket price to be suitable (represented in FIG. 4. as a “Good Price”), then the ticket is populated to a purchasing interface 108 for single action selection from a buyer. Note that although, in this diagram, the movement of a ticket is shown in one direction, i.e., it starts with the algorithmic pricing module 106B outputting a price and then the ticket is transferred from the automated pricing system 106 to a purchasing interface 108, all tickets on the exchange are regularly going through the automated pricing system 106 and having their prices updated. Therefore, tickets on a purchasing interface 108 will regularly have their prices updated by the automated pricing system 106, but will not be taken off of the exchange or purchasing interface 108 to do so. While a ticket's price is being updated, their previous price is available for purchase on a purchasing interface 108, and whatever price is listed when a user makes the signal to purchase will be their final purchase price. These updates may occur in regular intervals of time or any non-deterministic period of time as deemed necessary by the automated pricing system 106. The automated pricing system 106 thus also may contain logic necessary to keep track of all prices listed on the exchange and make decisions as to when each price needs to be updated through its system. Additionally, it is important to note that the automated pricing system 106 also works with tickets currently being sold on other retail ticketing platforms. Tickets are not limited to being sold just on the disclosed novel platform, but may also be communicated to other purchasing interfaces. Those skilled in the art will recognize this as a point of sale POS distribution model in the ticketing industry, with the present disclosure describing a novel form of such a model.

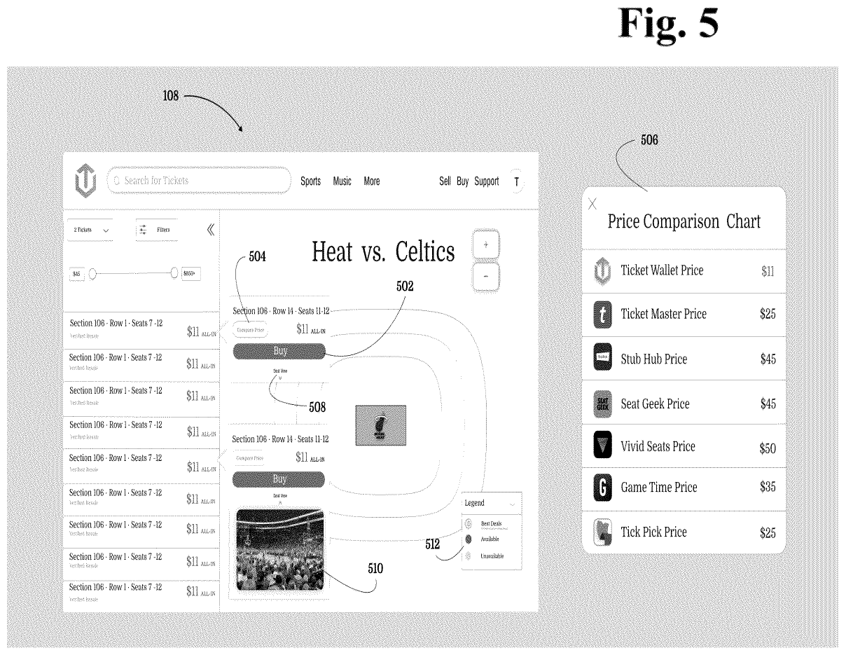

FIG. 5 illustrates an embodiment of a purchasing interface 108. The purchasing interface 108 serves to educate a potential ticket buyer on any information necessary to make a purchasing decision. The information included on a purchasing interface 108 may include seat location(s), seat price(s), a legend to indicate seat specific information 512, any packages included in the purchase (e.g., parking passes, lounge passes, food or drink coupons, etc.), a price comparison chart 506 between prices determined by the disclosed invention and other ticketing platforms, and or price statistics such as historical price trends. FIG. 5 thus represents a non-restrictive example of a purchasing interface 108 which may not include all the elements depicted therein and may include other elements, not depicted, which serve the functionality of this interface. The purchasing interface 108 can also include a single action control for a user to purchase a ticket (represented as a “Buy” button 502 in the illustration). This control allows a user to signal that they would like to buy the specified ticket at its current listing price which would then take the user through a standard checkout flow to complete such purchase. Other example controls include a button 504 to display the price comparison chart 506 and a button 508 to display a potential seat view 510. As mentioned above, the displayed prices may be continually updated by the automated pricing system 106 and a buyer agrees to whatever price is listed at the moment of their purchase signal. The UI in FIG. 4 is that which may be displayed on a website. However, any UI with the described functionality would encompass such a dashboard (e.g., the interface could be on a phone, tablet, etc.).

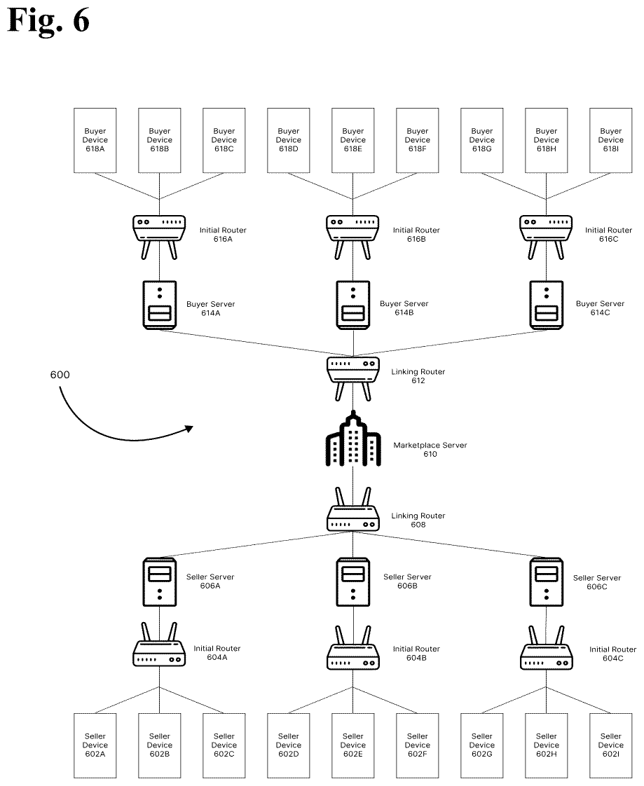

FIG. 6 illustrates an example of an embodiment of a network architecture to implement the disclosed technologies. The architecture, devices, servers, and routers displayed are simply embodiments of an example of a network for the disclosed technologies and are in no way intended to limit the implementation of the exchange described herein or its functionalities. Moreover, additional devices, servers, routers, or any other network device may be used to implement the methods of the disclosed technologies. Any of the devices 602A-6021 and/or 618A-6181 may be a phone, computer, tablet, or any device which allows a user to interact with the exchange. The exchange may be implemented as a marketplace server 610 or any device which allows a user to interact and perform the functionalities of the disclosed technologies. In this embodiment, a ticket seller would first connect to their local router 604A-604C which then, likely through a series of routers (not depicted), would pass their requests to a “seller server” 606A-606C. Similarly, a ticket buyer would first connect to their local router 616A-616C which then, likely through a series of routers (not depicted), would pass their requests to a “buyer server” 614A-614C. The communication between any device in the diagram and any server in the diagram may be through standard internet protocols e.g., Internet Protocol version 4 (IPv4), Internet Protocol version 6 (IPv6), Tor network protocols, or any other type of communication protocol which could facilitate the functionality between a user and the exchange outlined in the present disclosure. The routers 604A-604C, 616A-616C are therefore used to initiate and implement the seller or buyer's request. This could be through any means of data transfer and does not even have to include a router. An embodiment of such data communication would be through a Wi-Fi (“Wireless Fidelity”) router which contains an access point (AP, note though that not all routers contain access points). This router may emit radio waves which devices containing Wireless Network Interface Cards (WNIC) can pick up on and connect to. Upon successful completion of a connection handshake (which may include device verification and various other security protocols), the router would then typically connect the data sent (via network packets) in a Local Area Network (LAN) from a WNIC equipped device to a broader communication network such as the Internet. Any seller request that could influence a potential buyer (e.g., posting a ticket to a purchase interface 108) may be done through a marketplace server 610. Note that this does not necessarily have to be the communication protocol and, instead, the seller server and marketplace server may be one entity. On the other side of the exchange, a buyer device 618A-6181 would connect to a buyer server 614A-614C for any request that would not influence a seller. Any request that would impact a seller's environment (e.g., purchasing a ticket in the purchase interface 108) would be completed in the marketplace server 610. Again, this does not necessarily have to be the flow of communication and the buyer server 614A-614C may be the same entity as the marketplace server 610 or the seller server 606A-606C. Furthermore, the distinction between a buyer and a seller is not always clear and some users may be both buyers and sellers of tickets. Thus, this diagram does not limit the role of a user to be either a buyer or seller and is simply an embodiment of how the network may operate. Any server depicted in FIG. 6 may in reality be a collection of servers which together perform the functionalities described for that server in the present application. These servers include all algorithmic logic, hardware, software, data storage mechanisms, load balancing techniques, and monitoring applications necessary to perform said functionality in an efficient manner.

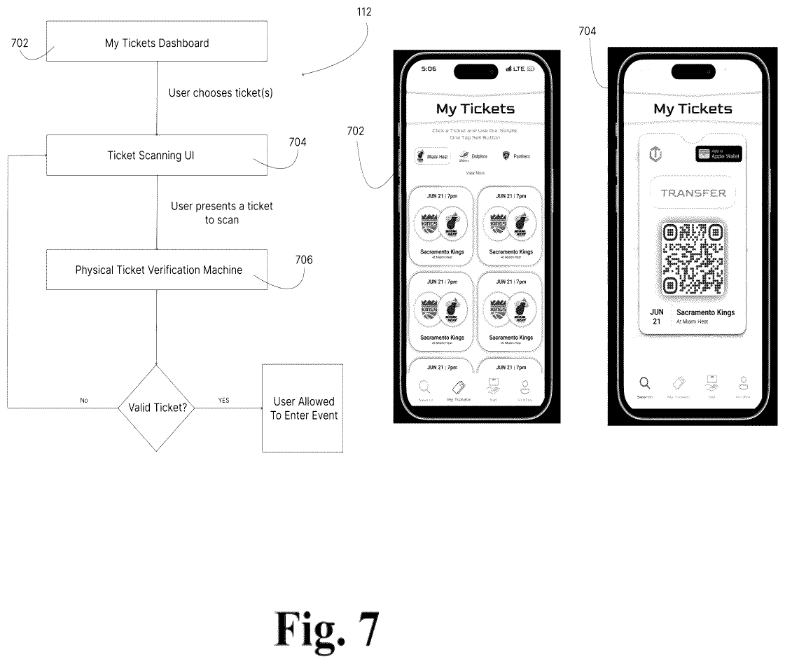

FIG. 7 depicts an embodiment of the event entry system 112. After successful purchase of a ticket from the automated selling system outlined herein, a user can use the ticket to gain access to an event. To do so, they must use a form of the ticket to be verified by a ticket verification machine 706. A form of the ticket includes, but is not limited to, a printed out copy (“paper ticket”), a mobile ticket, a QR code in any form, or a blockchain ownership ID (in the case of a blockchain form ticket). The ticket verification machine may encompass a gate or turnstile which will verify the ticket through a physical scanning mechanism or by electronic signals such as Bluetooth® or Near Field Communications (NFC) to verify the identity of the ticket. A user will find their tickets in their “My Tickets” dashboard 704, which provides an interface for a user to select which ticket(s) they would like to use to gain entry. An embodiment of this interface is depicted in FIG. 7, along with an example of a scanning mechanism which utilizes a QR code. The ticket verification machine 706 will only allow entry after the ticket is verified and will often be a physical gateway machine.

The disclosed technologies include not only an innovative system, but also represent an increase in efficiency in the time sensitive ticket selling market. Consider, for example, how the current system reacts to market changes versus the automated one described herein. Say that a man named Bill is a Lebron James super fan and has been saving up for tickets to go watch James' basketball team, the LA Lakers. Bill bought his Lakers tickets through a traditional ticket exchange and thus must resell them manually. In contrast, let us say that Jeff is using the automated selling system described herein and has decided to sell his tickets to the LA Lakers game 6 hours before the game starts. However, 4 hours before the game starts, Lebron James decides that his ankle, which has been bothering him for a couple of days, is too sore to play on that night. If Lebron James is a crucial player to the LA Lakers, then ticket prices may drop precipitously in value because people do not want to go to the game if Lebron is not playing (as is the case with our guy Bill). The automated pricing system 106 updates its data continually and is able to detect a massive drop in ticket price just minutes after Lebron is ruled out for the game with a combination of analyzing thousands of live tweets, Google® search trends data, and detecting changes in live ticket prices. The automated system is able to drop the price of Jeff's tickets rapidly which are then bought by a Lakers fan who has not yet heard the news about Lebron James being out. In contrast, Bill finds out, along with most other Lakers fans, just three and a half hours prior to game start that Lebron is not playing that day. He decides that he does not want to go to the game anymore because he really just wanted to see Lebron play. He goes onto the exchange and researches what prices the other LA Lakers tickets are now selling at which takes him about five minutes. During this research, Bill picks a price for his seats and then lists them on the market. Unknown to Bill, however, another Lakers fan who has tickets in the same row just found out about the same news and lists their tickets less than Bill's new price. Bill hopes that his tickets are sold and checks three hours before the game to find out that they are not. He then lowers his tickets' price again, but by this time the whole market is shifting quickly with everyone trying to have the lowest prices. Again Bill's tickets are not bought and, when he checks two and a half hours before the game, the prices are so low that he decides it is not even worth it to sell them and decides to go to the game anyway.

What is claimed is:

1. A system for selling, as a resale, a ticket to an event, the system comprising:
a processor;
a display;
a communications device;
an interface; and
a memory storing a module including instructions that cause the processor to:
receive, by the communications device, the ticket;
receive, by the communications device:
first price information, the first price information being associated with a position, at a location of the event, associated with the ticket, and
second price information, the second price information being associated with another position, the other position being in a vicinity of the position associated with the ticket,
wherein at least one of the first price information or the second price information is capable of being changed at a rate, perceived by a user of the system for selling, to be real time;
present, on the display, a representation of the location, the representation of the location including representations of:
the position associated with the ticket and the first price information, and
the other position and the second price information; and
cause, in response to a selection on the interface, the communications device to communicate the ticket to a system for facilitating the resale of the ticket.

2. The system of claim 1, wherein:
the ticket has a representation of data in a visual, machine-readable form, the data configured to cause a gate, at a location of the event, to open for a duration of time sufficient to deter anyone other than a bearer of the ticket to pass through the gate; and
the instructions further include instructions to cause, in response to the selection on the interface:
the communications device to be prevented from communicating the ticket to any other system, and
the visual, machine-readable form to be prevented from being presented on the display.

3. A system for buying, as a resale, a ticket to an event, the system comprising:
a processor;
a display;
a communications device;
an interface; and
a memory storing a module including instructions that cause the processor to:
receive, by the communications device and from a system for facilitating the resale of the ticket, price information associated with positions at a location of the event, wherein the price information is capable of being changed at a rate perceived, by a user of the system for buying, to be real time;
present, on the display, a representation of the location, the representation of the location including representations of the positions, the representation of the positions including, for a position associated with the ticket, a corresponding price ofthe price information;
cause, in response to a selection on the interface, the communications device to communicate a request to the system for facilitating, the request being an offer to buy the ticket at a specific price; and
receive, by the communications device and from the system for facilitating, the ticket.

4. The system of claim 3, wherein the ticket has a representation of data in a visual, machine-readable form, the data configured to cause a gate, at the location, to open for a duration of time sufficient to deter anyone other than a bearer of the ticket to pass through the gate.

5. A system for facilitating a resale of a ticket to an event, the system comprising:
a processor;
a communications device; and
a memory storing a module including instructions that cause the processor to:
receive, by the communications device and on a continual basis, information relevant to prices of positions at a location of the event;
determine, based on the information and at a continual rate, expected prices for the positions, wherein the expected prices are capable of being changed at a rate, perceived by at least one of a user of a system for selling, as the resale, the ticket or a user of a system for buying, as the resale, the ticket, to be real time;
cause, in response to determinations, at the continual rate, of the expected prices for the positions, a signal to be sent to at least one of the system for selling or the system for buying, the signal being configured to cause the at least one of the system for selling or the system for buying to present, on a display, a representation of the location, the representation of the location including representations of the positions, the representation of the positions including, for a position associated with the ticket, a corresponding expected price of the expected prices;
receive, by the communications device and from the system for selling, the ticket;
receive, by the communications device and from the system for buying, a request, the request being an offer to buy the ticket at a specific price; and
cause the communications device to communicate the ticket to the system for buying.

6. The system of claim 5, wherein:
the ticket has a representation of data in a visual, machine-readable form, the data configured to cause a gate, at the location, to open for a duration of time sufficient to deter anyone other than a bearer of the ticket to pass through the gate; and
the instructions further include instructions to cause the communications device to be prevented from communicating the ticket to any other system.
